(19) United States
(12) Patent Application Publication
(10) Pub. No.: US 2009/0129219 A1
(43) Pub. Date: May 21, 2009

(54) Recording/Reproducing Apparatus

(75) Inventor: Hiroyuki Marumori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/243,083

(22) Filed: Oct. 1, 2008

(30) Foreign Application Priority Data
Nov. 21, 2007 (JP) 2007-301169

(51) Int. Cl. G11B 20/10; H04N 5/00

(52) U.S. Cl. 369/47.1; 386/126; G9B/20.009; 386/E05.064

(57) ABSTRACT

In order to solve the above-described problems, in a camera using a BD as a recording medium, in order to prepare a menu compliant with a standard even when the finalizing is not required for the reproduction compatibility of a BD player, an application for a finalizing process is prepared automatically or manually, thereby providing a disc with which users can enjoy reproduction comfortably.

### INCORPORATION BY REFERENCE

The present application claims priority from Japanese application JP2007-301169 filed on Nov. 21, 2007, the content of which is hereby incorporated by reference into this application.

### BACKGROUND OF THE INVENTION

The present invention relates to disc recording/reproducing apparatuses having a DVD/BD or an HDD mounted therein.

In recent years, in the market of video cameras, the recording medium is making the transition to a disc from a tape for the reasons that there is no danger of being overwritten, that video retrieval is easy, and the like. Moreover, products having not only a DVD but also an HDD (Hard Disc Drive) or a semiconductor memory as the recording media mounted thereon are emerging in the market. For reference, an example of formats for recording data onto the DVD is introduced in JP-A-2003-308675. In the future, a further high capacity in the data media and a higher picture quality (toward HD) will be required. Recently, recorders employing the next generation optical disc standard Blu-ray Disc (BD) established by BDA (Blu-ray Disc Association) are emerging in the market in order to realize a higher capacity and higher picture quality, and in the future the applications to the video cameras can be easily envisioned.

Moreover, as one technique for realizing higher picture quality in the video camera, there is a need for a function to record HD (High Definition) pictures instead of the conventional SD (Standard Definition) pictures. However, in the current DVD, the HD pictures are not allowed to be recorded, and therefore the HD picture quality cannot be enjoyed if nothing is done. If the HD picture is -recorded, then you have to record the HD picture using the AVCHD (Advanced Video Codec High Definition) standard that allows for recording of the HD picture onto the conventional DVD, or you have to record the HD picture onto a BD and the like established by BDA. The AVCHD standard has been applied mainly to consumer cameras so that even the consumer cameras can record the HD picture. Moreover, the recording not only to DVD but also to an SD card or an HDD (hard disk) is also envisioned. However, in the AVCHD standard, since the HD picture is recorded on the conventional DVD, the shooting time cannot be very long. Since the 8 cm DVD has about 1.4 GB, shooting is possible only for around 20 minutes if the HD picture is recorded at 9 Mbps. Although the bit rate can be reduced or a two-layer disc can be used, shooting is possible only for around 40 minutes. However, since the capacity of an 8 cm BD is a little more than about 7 GB, the shooting time becomes no less than about 4 times as compared with DVD. For this reason, in the video camera that supports the HD recording, it is easily assumed that employing the BD disc is advantageous to the user.

### SUMMARY OF THE INVENTION

As described above, a camera that supports the recording/reproducing of the BD may be convenient to the user. However, in the current situation where there is no video camera that supports the BD, you have to use an AVCHD camera in order to keep the video in the HD picture. For this reason, the number of discs that are recorded based on the AVCHD will continue to increase until the BD camera emerges in the market. It is thus very convenient if there is reproduction compatibility with the AVCHD when the BD camera emerges in the market in the future. Moreover, the BD disc is more expensive than the DVD disc when the BD disc is introduced in the market, and it is therefore further convenient if the HD recording by using a DVD is also possible, in other words, if the recording is also possible with the AVCHD. That is, also when the BD camera emerges in the market in the future, the ability to support the AVCHD disc, which is the conventional property, in other words, having the AVCHD recording/reproducing compatibility feature will be extremely beneficial for the users.

Since the recording format of the AVCHD is extremely similar to the format of the BD standard, almost all the control software (libraries) and hardware properties can be used in common. The development man-hours and period for realizing the BD camera that supports the AVCHD standard can be reduced using these properties. Of course, the recording/reproducing with respect to the conventional DVD can be also supported using the conventional DVD properties.

Furthermore, a video menu for player compatibility that is generated in a finalizing process can be also commonized. The finalizing process in the conventional DVD camera refers to a process of shaping data in order to maintain the compatibility with the DVD player. This is required in the case of the DVD-R or the DVD-RW that supports the video format, or the DVD+RW or DVD+R compliant with the video recording format. Specifically, for maintaining the DVD-ROM compatibility, data (i.e., dummy data) is physically written to a position of 70 mm in the diameter direction, or the management information or file system is shaped, or a DVD menu is generated. FIG. 2 is a conceptual diagram of each medium and the corresponding menu. Reference numeral 230 represents a menu screen, wherein the data for OSD, the internal processing, and the like can be commonized by employing a unified menu design for either of BD, AVCHD, and DVD.

However, in the case of the BD (BD-RE), the physical recording of the dummy data, which has been required for conventional compatibility, is not required, and therefore, even if a user intentionally does not select the finalizing process that is prepared in the application, the import and the like of data is possible via the file system. That is, in terms of the reproduction compatibility, the finalizing process may not be carried out (you have to do this way). However, since the additional-recording prohibition information can be recorded on a disc, this recording may be executed as a part of the finalizing process, or usually, in the actual application to cameras, additional-recording is prohibited after the finalizing process. However, similarly, also in BD, we can stick to a policy (additional-recording is prohibited after the finalizing process) as the product by using the additional-recording prohibition information of the file system and the like. Furthermore, the finalizing process is carried out to the BD-RE to prohibit the additional-recording, thereby allowing the recorded picture to be protected. The finalizing process described above refers to a process that can be selected from the navigation screen of a camera, and, of course, the processing content varies for each medium.

In the BD-RE, such as the rewritable disc, the additional-recording can be enabled again (e.g., the written-once information is changed) through cancellation of the finalizing process, while in the case of the BD-R, since it is a write-once type medium, the additional-recording basically cannot be enabled again once the finalizing process is carried out. Moreover, in the case of the DVD-R, the player compatibility basically cannot be guaranteed because the un-finalized state is not specified. However, in the case of the BD-R, the compatibility with the BD player can be provided. In other words, in both the BD-RE and BD-R, in terms of the reproduction compatibility, the compatibility with the BD player can be provided even if a user intentionally does not select the finalizing process from the pull-down menu of the camera screen. However, since there is no menu at present, the reproduction may be possible only from the first scene when played on the player. If there is then a menu data (the data displayed using thumbnails of the shot scenes) compliant with BD, the scenes shot by a user can be reproduced from his/her favorite scene, which is very convenient for the user. Although the data configuration and the like differ between the BD and DVD, the usage could be said, for ease of understanding, to be similar to that of the DVD menu of the existing player. However, the information on a scene, the OSD data of the background constituting the screen, and the management information, and the like need to be generated in order to generate this menu data. Thus, it usually takes time. In the case of the camera, a photo opportunity is important, unlike the recorder. For this reason, it is a problem that it takes time before recording after inserting a disc or that it takes time in processing when stopping the recording. Accordingly, if the menu data is prepared each time after stopping the recording, a photo opportunity may be missed and it causes a disadvantage to the user. Then, as the camera, the menu data for the player compatibility is generated during the finalizing process, which is intentionally carried out by the user, not at the timing before or after recording, so that a photo opportunity may not be missed. In this way, without missing a photo opportunity, the menu can be generated when the user desires, and comfortable reproduction in the BD player can be enjoyed.

Of course, if the time required to prepare the menu is such a short time period during which a photo opportunity is not missed, the menu may be automatically generated at the time of ejection. In this case, since the finalizing process may not be carried out intentionally, a further user-friendly specification is provided.

According to the present specification, as described above, in the BD camera, a menu compliant with the standard is processed in the finalizing process or the menu is automatically generated at the time of ejection, so that an information recording/reproducing apparatus that allows users to enjoy a comfortable reproduction in the BD player without missing a photo opportunity can be provided.

In order to realize the above-described apparatus, there is provided an information recording/reproducing apparatus having a drive device compliant with a plurality of recording media provided therein and being capable of carrying out recording/reproducing compliant with a standard corresponding to the recording medium, wherein even in the case where the recording medium does not require finalizing, in order to generate information compliant with the standard or in order to provide compatibility in a reproducing apparatus compliant with the standard, a finalizing process is carried out when there is a request from a user or automatically, thereby generating a menu compliant with the standard.

The present invention provides an information recording/reproducing apparatus with increased convenience and usability.

These and other features, objects and advantages of the present invention will become more apparent from the following description when taken in conjunction with the accompanying drawings.

### BRIEF DESCRIPTION OF THE DRAWINGS

FIG. 1 is a configuration diagram of a system in an embodiment of the present invention.

FIG. 2 is a conceptual diagram of a menu prepared in the embodiment of the present invention.

FIG. 3 is a conceptual diagram of a finalizing process which a user carries out in the embodiment of the present invention.

FIG. 4 is a flow chart of the finalizing process in the embodiment of the present invention.

### DETAILED DESCRIPTION OF THE EMBODIMENTS

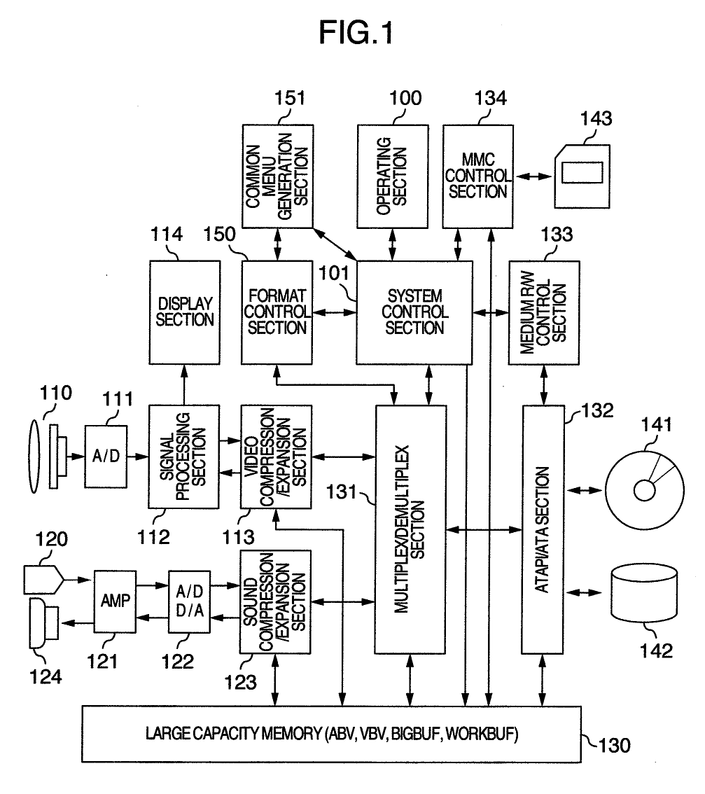

Hereinafter, the embodiments of the present invention will be described with reference to FIG. 1 to FIG. 4. FIG. 1 is a block diagram showing a camera-integrated recorder. Referring to FIG. 1, reference numeral 100 represents an operating section that is operated by a user, which includes a record/stop key, a zoom key, a select key of a record mode, and the like. Reference numeral 101 represents a system control section that overall controls the respective sections of multiplex/de-multiplex processing, controlling read-write to a medium, controlling various kinds of formats, and the like. Reference numeral 110 represents an optical lens for imaging an object, and a CCD sensor or a CMOS sensor that is a photoelectric conversion module for converting the imaged light into an electric signal, 111 represents an A/D converter that converts the video electric signal into a digital signal, 112 represents a signal processing section that carries out processing for converting the video information that has been converted into the digital signal into a video signal, 113 represents a video compression/expansion section that compresses and expands the video signal according to a given encoding system such as MPEG or H.264, and 114 represents a display section that displays the video. Note that the display section 114 may be separated into a display section inside a finder, and a movable display section that is disposed outside the casing of a video camera. Moreover, reference numeral 120 represents a microphone that converts a collected sound into an electric audio signal, 124 represents a speaker that generates a sound, 121 represents an amplifier that amplifies the audio signal, 122 represents an A/D converter (D/A converter) that converts the audio electric signal (from) into a digital signal. Reference numeral 123 represents an audio compression/expansion section that compresses and expands the digital audio according to a given encoding system such as Dolby Digital or MPEG, 131 represents a multiplex section that multiplexes a moving picture compression stream that has been generated by the video compression/expansion section 113 and an audio compression stream that has been generated by the audio compression/expansion section 123, and 130 is a large-capacity memory that temporarily stores the video data that has been compressed by the video compression/expansion section 113, audio data that has been compressed by the audio compression/expansion section 123, and data resulting from multiplexing the video data and the audio data. Moreover, an ATAPI/ATA section 132 represents an interface section that complies with a specific standard, and 141 represents an optical disc, e.g., a BD, a DVD, and the like. Moreover, reference numeral 142 represents a recording medium, such as an HDD (hard disk). A medium R/W control section 133 carries out control for reading and writing a data file of a moving picture to be recorded and reproduced with respect to a recording medium BD, or a DVD 141, or an HDD 142 in a given file format.

Reference numeral 150 represents a format control section that identifies the type of the recording medium to generate the information compliant with the various kinds of formats, such as a subset of BDMV, a VR format, a VF format, an AVCHD format. Furthermore, in finalizing, the shaping for maintaining compatibility of the management information or file system is carried out. A common menu generation section 151 generates menu data that is to be generated in finalizing. Reference numeral 134 represents an MMC control section, which is used in recording on a medium 143 having an MMC interface such as an SD card. Although the MMC control section 134 usually records static pictures, video data may be recorded after converting the result of the multiplex/separation section into a given format.

In this example, the respective functions of the video compression/expansion section 113, the audio compression/expansion section 123, the multiplex/separation section 131, the format control section 150, and the system control section 100 are preferably realized by executing programs by a microprocessor. However, a part or all of those programs may be configured by hardware. Moreover, in FIG. 1, control lines and information lines that may be necessary for the purpose of explanation are illustrated, however, in terms of the product, all of the control lines and the information lines are not necessarily illustrated.

Next, the recording operation is described. In the case where a moving picture shooting mode is selected by the operation of the operating section 100, the system control section 100 recognizes the selection, and controls the overall system as follows. The CCD or CMOS sensor 110 is driven to a moving picture signal generating mode by a drive section (not shown). Then, the image formed by the optical lens is converted into an electric signal by the CCD or CMOS sensor 110, and then converted into a digital signal by the A/D converter 111, and then the digital data is converted into the video data by the signal processing section 112. Thereafter, the video data is compressed by the video compression/expansion section 113. In the compressing process, the video data is sequentially converted into the moving picture compression stream while the video data that is being compressed is transferred between the memory 130 and the video compression/expansion section 113. On the other hand, the sound that has been collected by the microphone 120 is compressed by the audio compression/expansion section 123 through the AMP 122 and the A/D converter, and then temporarily stored in the memory 130. Thereafter, the moving picture compression stream that has been generated by the video compression/expansion section 113 and the audio compression stream that has been generated by the audio compression/expansion section 123, which are currently stored in the memory 130, are multiplexed by the multiplex/separation section 131, and the multiplexed data is temporarily stored in the memory 130. At this time, the format control section constructs a format compliant with a standard. Finally, the multiplexed data is output from the memory 130, and then recorded on the recording medium DVD or the BD 141, and the HDD 142 in the given recording format through the medium R/W control section 133 and the ATAPI/ATA section 132. In this case, the multiplexed data may be recorded on either of them, or may be recorded on both of them at the same time. In this embodiment, it is assumed that reference numeral 141 represents the BD-RE. If the multiplexed data is recorded on the HDD 142 in the same application format (BDMV subset) as that of the BD-RE, this has also an advantage that the data transfer can be carried out efficiently in dubbing from HDD to BD.

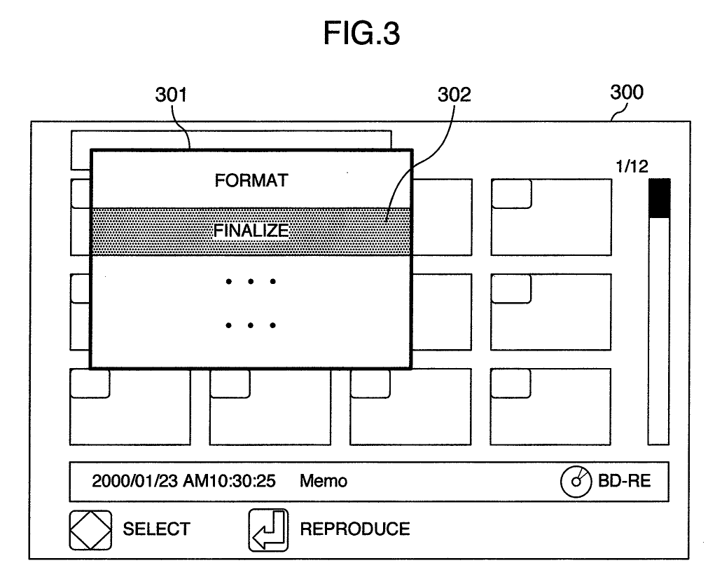

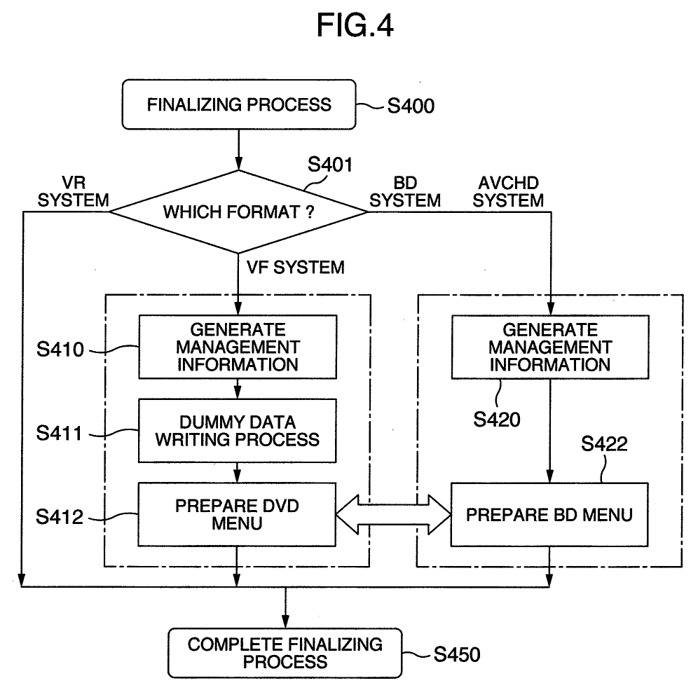

Next, the processing when a user carries out the finalizing of BD is described using FIG. 1, FIG. 3, and FIG. 4.

Assume the case where the finalizing process is carried out after the recording of six scenes is carried out. FIG. 3 is a view of a pull-down menu for a user to execute the finalizing process. Reference numeral 300 represents the camera-specific navigation screen, where shot scenes are displayed as thumbnails. Moreover, the information on the used medium is also displayed. Reference numeral 301 represents the pull-down menu, and 302 indicates that the finalizing process is being selected. Usually, in the DVD or BD camera, taking into consideration the usability, a unique navigation menu is often used without using a menu of the appropriate standard. Also in this embodiment, it is assumed that a unique navigation menu is used. If a user selects the finalize 302 and executes a determine-button (not shown), then the finalizing process will be executed. These operations may be executed not only by the pull-down menu, but also by an operation button that is attached to the apparatus for executing the finalizing. This allows a user to carry out the finalize operation easily.

FIG. 4 is a flow showing the control of the finalizing process. S400 indicates an instruction to start, S401 represents a format determination process, S410 represents a management information generation process for DVD, S411 represents dummy data processing, and S412 represents a menu data generation process for DVD. S420 represents a management information generation process for the BDMV or BDMV subset. Specifically, in S420, the generation, shaping, or the like of index.bdmv (for describing how to reproduce under what kind of title, and the like) and Movieobject.bdmv (for describing a specific reproduction method and the like) is carried out. These files are essential for the reproduction by the BD player. If there are other measures required to reproduce by the player, these are carried out here. S422 represents a menu data generation process for BD. Specifically, in S422, a thumbnail for display is prepared, and the thumbnail overlapped by a background or the like is compressed to finally prepare xxxxx.m2ts (compressed stream) and xxxxx.clpi (stream information of the corresponding m2ts) (xxxxx is the number in the ascending order from 0, and in the case of the menu, it is set to a number, which has been recorded before finalizing, +1). Moreover, a play list 0yyyy.m2ts file for managing these is generated (for the yyyy, the numbers from 1200 to 1999 are reserved as the menu). For example, in the case where the menu is prepared after recording two scenes, the play list 0yyyy.m2ts file is as follows. Followed by ¥¥BDMV¥STREAM: 00000.m2ts . . . . video and voice data of the first scene 00001.m2ts . . . video and voice data of the second scene 00002.m2ts . . . followed by the menu data of the above-described two scenes ¥¥BDMV¥CLIPINF: 00000.dpi . . . management information of the stream of 00000.m2ts (reproduction time, position, and the like) 00001.clpi . . . management information of the stream of 00001.m2ts (reproduction time, position, and the like) 00002.dpi . . . management information of the stream of 00002.m2ts (reproduction time, position, and the like) ¥¥BDMV¥PLAYLIST: 00000.mpls . . . management information of the stream of the first and second scenes 01200.m2ts . . . management information of the menu data stream. S450 indicates the completion of the processing.

In the state where six scenes are recorded, a user indicates the finalizing process from the pull-down menu of FIG. 3. Internally, the system control section 101 decodes the information received from the operating section 100, and recognizes this information as the finalizing process and thereafter requests each block for the processing. The system control section 101 always knows the recorded format, and this information can be obtained as needed. Moreover, the processing related to the management information of BD or DVD that is carried out during the finalizing process, is carried out by the format control section 150, while the processing, such as the shaping of the file or the shaping of the file system, is carried out by the medium R/W control section 133. For example, the finalizing process can be executed by carrying out the above-described operations to the BD-RE as the recording medium. In this case, the “additional-recording prohibition” processing may be carried out to the BD-RE. Thus, by carrying out the finalizing process to the BD-RE, the written data can be protected.

Moreover, the preparation and the like of the characteristic menu of the present specification are carried out by the common menu generation section 151. Specifically, the common background data is prepared, and a thumbnail is stuck thereon, and the resultant data is converted into a compression stream as needed. For example, the compression stream is prepared by carrying out the MPEG2 compression in the case of DVD, while in the case of BD, the compression stream is prepared by carrying out the H.264 compression. For example, in the video camera, by preparing the menu at the time of the finalizing process in this manner, the shooting can be carried out without missing a photo opportunity, thus increasing the convenience for users.

If the finalizing is executed in FIG. 3, the processing starts in S400. First, the format is checked. This is done because the finalizing process differs depending on the formats. First, in the case of the VR format of DVD, nothing is done because this basically does not require the finalizing process. However, the path of the VR system is not necessary if the path is prevented from being displayed at the time of the VR in the pull-down menu of FIG. 3. Next, in the case of the VF format, this path is necessary for the reproduction compatibility in the existing DVD player. In S410, the management information compliant with the standard and the type of the file system are arranged. Next, in S411, a specified amount of dummy data is recorded in order to be compliant with the physical standard of the ROM. Finally, the DVD menu is prepared in S412. The process sequence from S410 to S412 is not limited in particular, and may be changed as needed. Next, in the case of the BD, although this format needs to be compliant with the BDMV subset, the basic configuration of the AVCHD is also the same as that of the BDMV subset. From this fact, these processings can be unified.

In this circumstance, upon selection of the BD or AVCHD format in S401, the management information of the BDMV subset and the file system are prepared in S420. Thereafter, although the menu for the BDMV subset is prepared in S422, this is configured so as to be compliant also with the AVCHD format. Moreover, in this case, by reusing the background data as needed which has been used in preparing the DVD menu in S412, the development efficiency can be increased. For example, the background data with the aspect ratio of 4:3 is prepared in advance, and then in the case of the aspect ratio of 16:9, the background can be prepared by expanding the data of 4:3. Since the design and the like of the background can be made the same even if there is a difference in the aspect ratio, the integrity can be maintained as an added benefit.

Furthermore, the “additional-recording prohibition” processing may be executed prior to completion in S450. Usually, in the finalizing process of the DVD system, the additional-recording is prohibited, however, also in the BD-RE, the specification that “the additional-recording shall be prohibited if the finalizing process is carried out” would rather allow to stick to the policy as the product. This allows a user to operate without being confused, which is convenient for the user. Moreover, the data written to the BD-RE can be protected. Of course, in the case of the BD-RE, such as the rewritable type, addition of the function to cancel the finalizing, i.e., to cancel the write-once, would provide a more user-friendly specification.

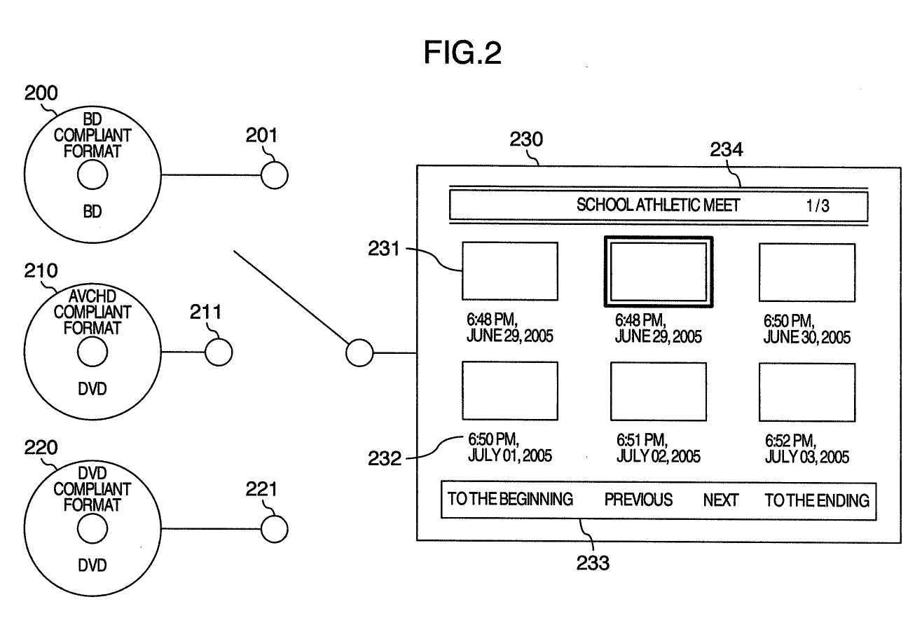

FIG. 2 is a conceptual diagram of the actual menu. Reference numeral 200 represents a BD that is recorded based on the BDMV subset, 210 represents a DVD that is recorded in the AVCHD format, and 220 represents a DVD that is recorded based on the conventional VF, +VR (VF-compliant). Moreover, reference numerals 201, 211, and 221 represent imaged connections for indicating that the respective media can be used in any menu. Reference numeral 230 represents the whole menu. Reference numeral 231 represents a thumbnail of a shot video, and 232 represents the shooting date and time of the video. Reference numeral 233 represents a menu for user commands, i.e., select and page forward. Reference numeral 234 represents a display of the title of a shot picture group. The user is permitted to specify this in the finalizing. Of course, the preparation timing is not limited in particular. If the processing in FIG. 4 is executed normally, the menu configuration and the design, which are integrated across the cases of DVD, AVCHD, and BD as shown in FIG. 2, can be realized. Moreover, the structure and the like of the thumbnail may vary slightly depending on the difference between 4:3 and 16:9 of the aspect ratio of the thumbnail, the difference between SD (Standard Definition) and HD (High Definition), or the like.

As described above, in a camera using the BD as the recording medium, in order to prepare a menu compliant with the standard even when the finalizing is not required for the reproduction compatibility of the BD player, the finalizing process is carried out automatically or manually, thereby providing a disc with which users can enjoy reproduction comfortably. Moreover, the development man-hours can be reduced by making the on-screen data (OSD) and the design, or the generation processing of the BD menu common with those of the DVD or AVCHD.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

It should be further understood by those skilled in the art that although the foregoing description has been made on embodiments of the invention, the invention is not limited thereto and various changes and modifications may be made without departing from the spirit of the invention and the scope of the appended claims.

1. An information recording/reproduction apparatus that carries out recording or reproducing compliant with a standard to a recording medium, comprising:
a finalizing module, carrying out a finalizing process to a recording medium that does not require finalizing for reproducing compatibility; and
a control module, in carrying out the finalizing process by the finalizing module, generating information compliant with the standard and recording the information compliant with the standard on the recording medium.

2. The information recording/reproduction apparatus according to claim 1, wherein
the information compliant with the standard is menu data compliant with the standard, and wherein
the menu data can be displayed with a reproducing apparatus compliant with the standard.

3. An information recording/reproducing apparatus having a drive device compliant with a plurality of recording media mounted therein and being capable of carrying out recording/reproducing compliant with a standard corresponding to the recording medium, comprising:
a finalizing module, carrying out, when one of the recording media is a DVD and other recording media are BDs, a finalizing process not only to the DVD but also to the BDs when there is a request from a user or automatically.

4. The information recording/reproducing apparatus according to claim 3, wherein menu data compliant with a subset of BDMV is generated by carrying out a finalizing process in the BD.

5. The information recording/reproducing apparatus according to claim 4, wherein in the DVD, recording is made not only in a video recording format or a video format, but also in an AVCHD format.

6. The information recording/reproducing apparatus according to claim 2, wherein the menu data has a common part with a design, data, and processing of menu data that is generated in a finalizing process of the AVCHD format.

7. The information recording/reproducing apparatus according to claim 2, wherein the same design, data, and processing as those of menu data that is generated in a finalizing process of the DVD are used for the menu data.

8. The information recording/reproducing apparatus according to claim 6, wherein once the finalizing process is carried out in not only rewritable AVCHD or DVD but also a rewritable BD, additional-recording is prohibited thereafter.

9. The information recording/reproducing apparatus according to claim 8, wherein the additional-recording is enabled if the finalizing process is canceled.

10. The information recording/reproducing apparatus according to claim 9 capable of recording on an HDD in a format compliant with a BD standard.

11. A video camera comprising a drive device compliant with BD, DVD, and HDD mounted therein, the video camera comprising: a device that controls reading and writing of a recorded video to a recording medium; a system control CPU that manages arbitration or determination of each block, and also a whole system; a format control section for realizing a specified recording format; and a system control section that carries out CODEC control compliant with each standard, wherein
also in the case of a BD, a finalizing process is carried out automatically or manually, and wherein menu data compliant with a BD standard that is generated at this time can be made common with menu data that is generated in a finalizing process of an AVCHD or a DVD, or common with a design thereof.

12. A video camera capable of recording information onto a BD-RE or reproducing information from the BD-RE, the video camera comprising:
a photoelectric conversion module that images a subject and converts this image into an electric signal; and
a finalizing execution module that carries out a finalizing process to the BD-RE.

13. The video camera according to claim 12, wherein in carrying out a finalizing process by the finalizing execution module, a first menu data compliant with a subset of BDMV is generated.

14. The video camera according to claim 13 capable of recording or reproducing information with respect to a DVD in an AVCHD format, wherein the finalizing execution module can carry out a finalizing process also to the DVD.

15. The video camera according to claim 14, wherein the first menu data has a design, data, or processing that is made common with a part of a second menu data generated in the finalizing process of the AVCHD format.

16. The video camera according to claim 12 having an operation button or an operation menu for carrying out finalizing by the finalizing execution module.
